(19) United States
(12) Patent Application Publication
(10) Pub. No.: US 2012/0011752 A1
(43) Pub. Date: Jan. 19, 2012

(54) Display

(75) Inventor: Camilo Basilio Schutte, Amsterdam (NL)

(73) Assignee: CBSG INVERSIO B.V., Amsterdam (NL)

(21) Appl. No.: 13/147,170

(22) PCT Filed: Jan. 28, 2010
(86) PCT No.: PCT/NL2010/050040

§ 371 Date: Sep. 28, 2011

(30) Foreign Application Priority Data
Jan. 29, 2009 (NL) 2002465

(51) Int. Cl. G09F 7/22; G09F 1/10

(52) U.S. Cl. 40/533

(57) ABSTRACT

A display is provided that includes a plurality of panels that are disposed for movement about a single flipping edge only. The panels may each be flipped manually about said flipping edge from a first position in which one face of the panel faces front, to a second position in which an opposite face of that panel faces front. The display includes at least one set of two panels, which panels are disposed such that their flipping edges include an angle so as to extend at least partially transversely relative to each other, and such that one of their positions at least partially overlaps.

The invention relates to a display.

Displays are commonly used to attract the interest of a public. Presently, it is common to provide displays of which the appearance may be changed, for example a video wall, to make the display more interesting for the public to look at.

U.S. Pat. No. 4,094,083 discloses a display for use on a paneled door of a truck. The display includes a base with a top portion and a bottom portion that are hingedly connected. The top portion and the bottom portion each carry a number of panels that are disposed for movement about a single flipping edge only, and that may each be flipped manually about said flipping edge from a first position in which one face of the panel faces front, to a second position in which an opposite face of that panel faces front. The flipping edges of the set of two panels extend collinearly to allow the image displayed at a top portion of the display to be matched up with a bottom portion of the display.

A drawback of such a display is that it may only catch the public's eye for a short while, and may not sufficiently arouse the public's interest to keep looking. The invention aims to provide an alternative type of display that aims at arousing the public's interest more.

Thereto, the invention provides for a display including a plurality of panels that are disposed for movement about a single flipping edge only, wherein the panels may each be flipped manually about said flipping edge from a first position in which one face of the panel faces front, to a second position in which an opposite face of that panel faces front, the display including at least one set of two panels, characterized in that the panels of said set are disposed such that their flipping edges include an angle so as to extend at least partially transversely relative to each other, and such that one of their positions at least partially overlaps.

By providing the display with panels that may be manually flipped about a flipping edge, the public may interact with the display in a simple and inviting way. By disposing the panel such that their flipping edges include an angle such that one of the positions at least partially overlaps, the appearance of the display may be changed by the public in an intriguing and unexpected way. By disposing the panels for movement about a single flipping edge only, the possibilities to change the appearance of the display includes a limitation, which allows the provider of the display to embed a number of predetermined appearances. These appearances are—due to their limited number—still inviting for the public to explore. The combination of the features of claim 1 allows for a display which invites the public to change its appearance manually and which operates in an intriguing way. It is therefore possible to compose the display in a predetermined way by choosing the orientation of the flipping edges and the grouping of the panels, and yet still produce appearances of the display that may even be surprising to the composer.

The panels of the set may each be disposed to hinge about an axis extending substantially along the flipping edge of the panel and the hinge axes may extend at an angle relative to each other. Such a hinge axis may be a mathematical or geometrical axis, but may also be a physical axis. The axis may be fixed or variable, for example when the panel is disposed to hinge via a living hinge construction.

The first and second position may lie in a substantially flat plane. In such a configuration, the display may extend e.g. substantially vertical on a wall in a base plane. In such a configuration, the axes may extend substantially in the same plane. As an alternative, the first and second positions may lie in intersecting planes, for example in a cubic configuration of the display.

By allowing at least one of the panels to be placed in at least one intermediate position located between the first and second position, further possibilities to change the appearance of the display may be added. This may make the display more intriguing. A panel may e.g. extend in a flat plane that intersects a base plane of the display at an angle, and may e.g. be arranged to be held in that orientation.

By providing more than one set of two panels that are disposed with their flipping edges extending at an angle relative to each other, and having one of their positions at least partially overlapping, so that the panels of that set may overlap at least partially in another common position, the possibility to change the appearance of the display is increased further. The display may for example include four panels of which two may be arranged disposed to be flipped about adjacent upright flipping edges, and of which the remaining two are arranged to be flipped about adjacent transverse flipping edges that intersect with the upright flipping edges to form a cross. An even larger arrangement may e.g. include an array of rows and columns that each include three or more panels.

By providing at least one set of panels that include a plurality of panels that is grouped with their flipping edges in a bundle, the possibilities to change the appearance of the display are increased further. In such a configuration, a number of panels may thus be disposed in a bundle to hinge about the same axis. As alternative or in addition, the display may also include a number of panels which may not be flipped about an axis and that are stationary. The provision of a number of such stationary panels may be used to deliberately limit the number of configurations that the display may assume in certain areas.

By hingedly disposing the panels on connections, preferably hinges, flipping a panel about its longitudinal flipping edge may be realised efficiently and reliably. The hinges may e.g. be configured as linear hinges. To facilitate assembly and to facilitate exchanging panels, the panels may be releasably carried on the hinges. To limit the number of possible configurations of the display, the panels may be disposed to have only one degree of freedom, which is a rotation about a flipping edge.

The panels may be supported on a carrier, e.g. a plate or a frame that may define a base plane. As an alternative, the panels may be mounted to a wall or other external structure that forms a base plane. The panels may be mounted to the carrier or external structure via at least one connection so as to be able to be flipped about a flipping edge, e.g. a hinge construction. Such connection may alternatively include rings, elastic joints, or bookbinding joints. Such connection may carry one or more panels, and the panels may remain attached to the connection during the flipping movement. The connections may be configured such, that a panel may be flipped to cover adjacent positions with or without panels, and may be covered by an adjacent panel.

The carrier may be built up of a number of carrier segments to facilitate transport and assembly of the display. Preferably, each carrier segment corresponds with a position of a panel. This way, the dimensions of the carrier segments may be chosen relatively small. The carrier segments may be detachably interconnected to facilitate assembly and disassembly of the display. The carrier segments may e.g. also be interconnected, e.g. via fold lines so that the carrier may be embodied as a collapsible carrier of which the segments may fold in or out.

By interconnecting the carrier plates via connections that carry panels at their flipping edges, the display may be provided with an elegant yet simple construction of a modular nature. Elegantly, the hinges may for example be embodied as double or triple ring clamp mechanisms of the type that are commonly used in ring binders.

The basic shape of the panels may be mutually substantially the same to optimize the overlapping effect. To maximise overlap, adjacent panels may be chosen to be line symmetrical, for example Isosceles triangles, rectangles or equilateral pentagons. However, varying the basic shape of a number of panels may allow yet more configurations of the display.

The panels may be polygonal, and are advantageously square or rectangular. The flipping edges of the set of panels may for example extend at an angle of about 90 degrees. The included angle may also be chosen differently, e.g. 30°, 45° or 60° , e.g. depending on the shape of the panels.

By embodying the panels to be rigid, the panels may keep a planar configuration. The panels may e.g. be made of, paper, cardboard, fibre, wood, metal, plastic, laminate, glass and combinations thereof, or of any other suitable type of material. By providing one or more panels that is transparent or translucent, the underlying panel may be made at least partially visible when the panels overlap. Further, the perimeter and/or the faces of at least a number of the panels may be provided with cut outs, apertures, embossing, engraving or texture. To allow flipping edges of adjacent panels to be positioned in close proximity, the area along unhinged flipping edges of the panels may be provided with apertures, such as open slits, to accommodate parts of the hinges without enclosing. The area along hinged flipping edges of the panel may then be provided with apertures, such as holes, that enclose parts of the hinges.

At least one of the panels may be arranged to display an image and/or information on at least one of the faces, for example a photograph or lettering. Both faces of a panel may provide a visual effect when they are facing front, e.g. a picture, a photograph, text, a drawing, a colour filter etc. As an alternative or in addition, at least one or more of the panels may be arranged to carry objects. Also, the panels may be arranged to emit or transmit light and may e.g. include LED light, glass fibres or an LCD display.

The invention also relates to a kit for a display, comprising a plurality of panels, a carrier and a plurality of hinges. Such a kit may be used to assemble a display as discussed above, and allows the display to be transported relatively easily in disassembled state. The carrier may then e.g. be segmented so that each segment corresponds with a position of a panel. In such configuration, the panels and the carrier may be contained in a housing of which the basic length and width dimensions correspond to those of a panel or carrier segment. The hinges may then be used to both interconnect the carrier plates and to hingeably carry the panels. Advantageously, the panels, the carriers and the hinges may be included in such housing, together with e.g. a set of assembly instructions.

The invention also relates to a method of operating a display, in which panels may be flipped about a flipping edge from a first position in which one face of the panel faces front, to a second position in which an opposite face of that panel faces front, in which the panels are flipped so as to arrive at a common position from directions that are orientated substantially transversely.

The display may for example be used as an art object or a decoration, e.g. to display a number of different photographs. The creator of the display, for example an artist, may provide the panels with a number of images and arrange the images such that the display may tell different stories when the panels are in different configurations. The public may then flip the panels to change the display, e.g. to adapt it to the mood, the time of day or the season of the year, or just to give it a fresh appearance. The panels of the display may for example be partially pre-provided, so that a user may add panels of his own choice at a later stage.

The display may for example also be used to give a presentation with, and to capture the audiences' attention. For example, an architect may provide the faces of the panels with information on a new building, e.g. external and internal photographs, drawings, style details and fabric examples. By flipping the panels, the public may then get a much better feel for the atmosphere in the building, and may compare different style options.

The display may also be used for educational purposes. By flipping panels, children may for example explore relations between objects displayed on the panels. In addition, the display may also be embodied to be a puzzle or a game.

The display may further for example be used as a gift item that can be sold at e.g. a museum store, for example when the faces of the panels depict works of art, details of works of art and information on the museum or artists that may be interactively discovered manually by flipping the panels. Further, the display may e.g. be placed in public places, e.g. at a railroad platform, to present a range of products that the waiting public may discover by flipping the panels.

The invention shall be illustrated further using two exemplary embodiments that are shown in a drawing. In the drawing,

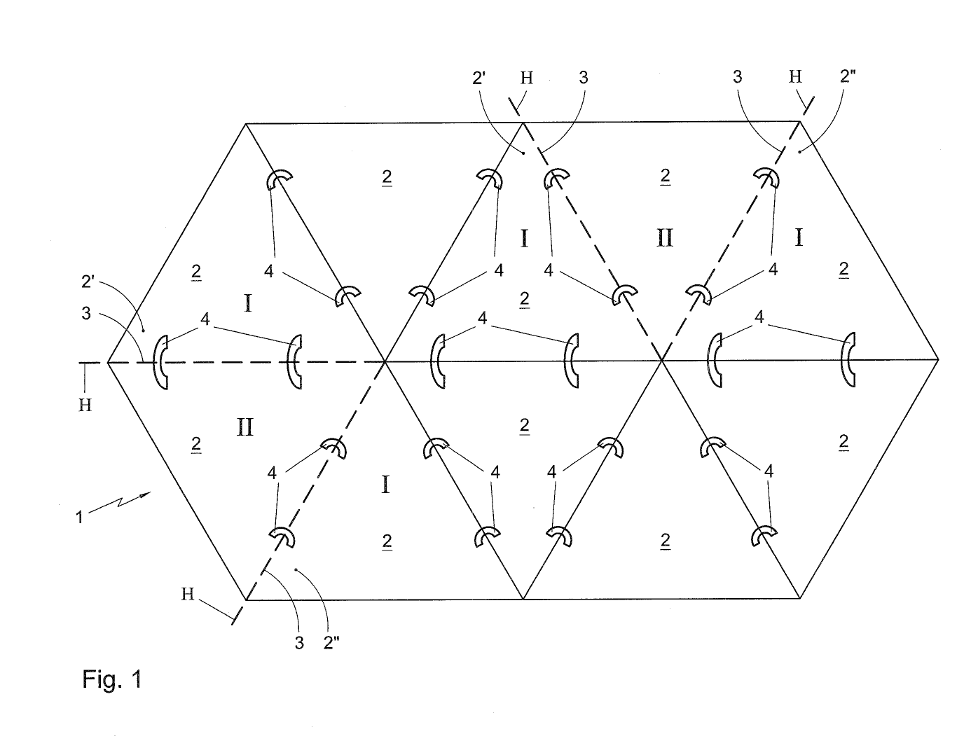

FIG. 1 is a schematic top view of a display;

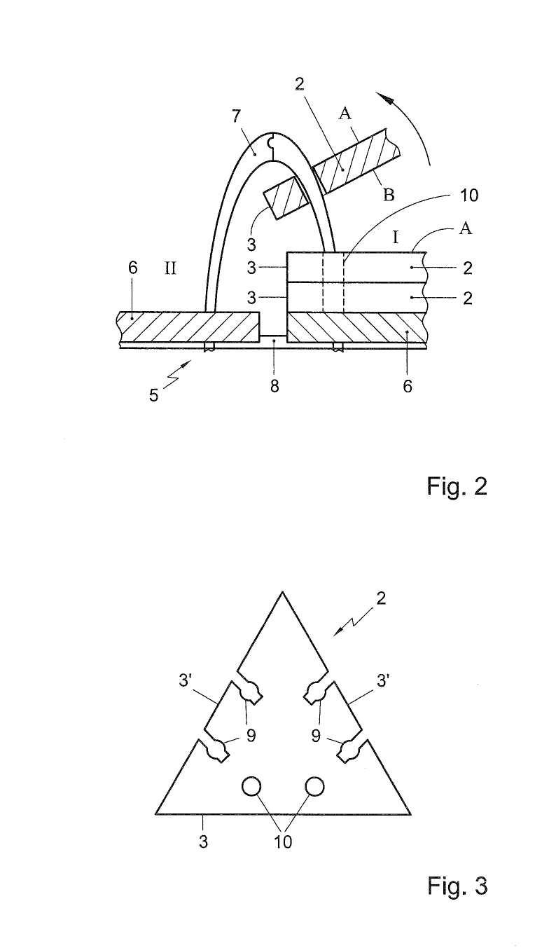

FIG. 2 shows a schematic cross section in a side view of a detail of a panel of the display of FIG. 1 being flipped, and

FIG. 3 shows a schematic top view of a panel of the display of FIG. 1 with enlarged apertures;

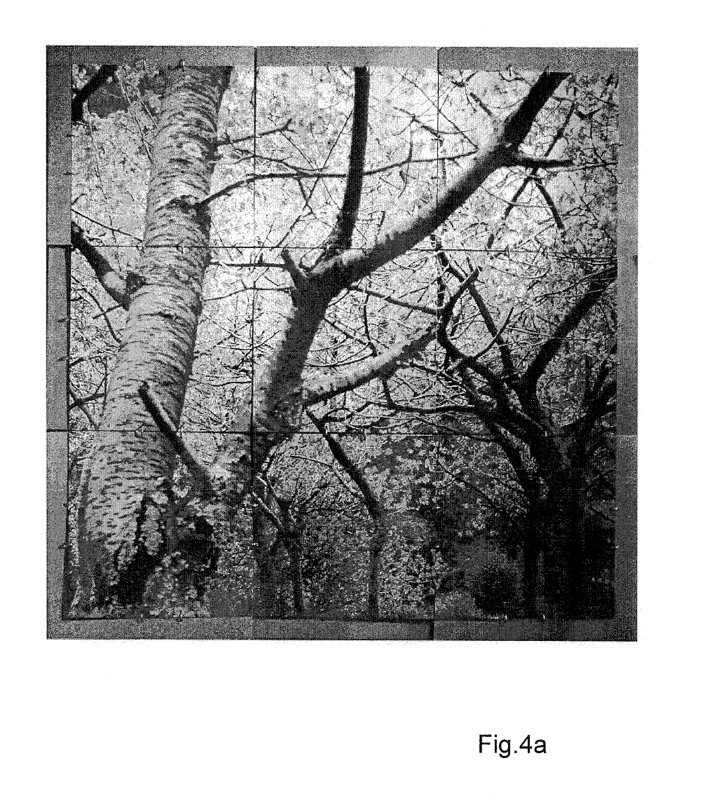

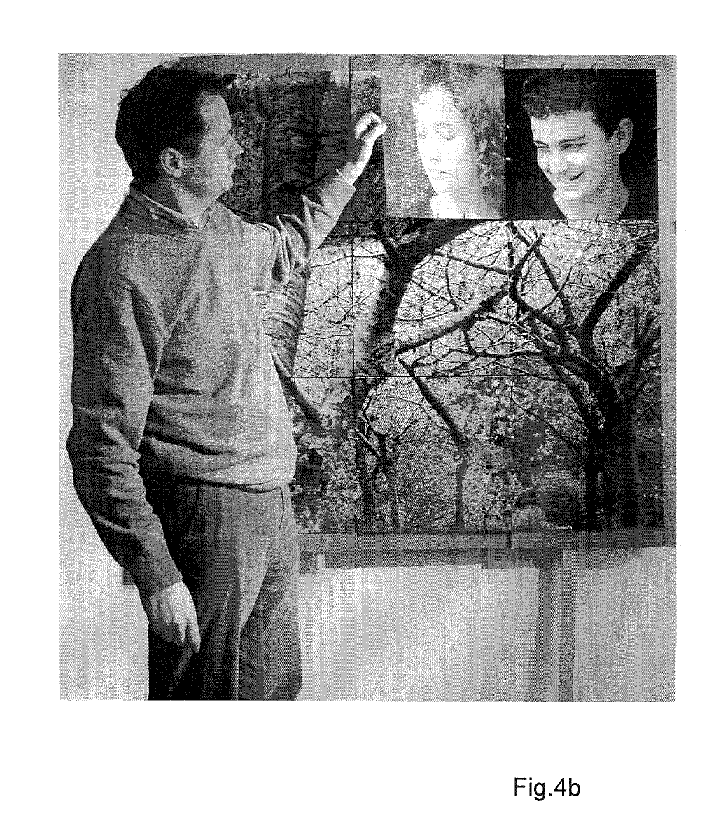

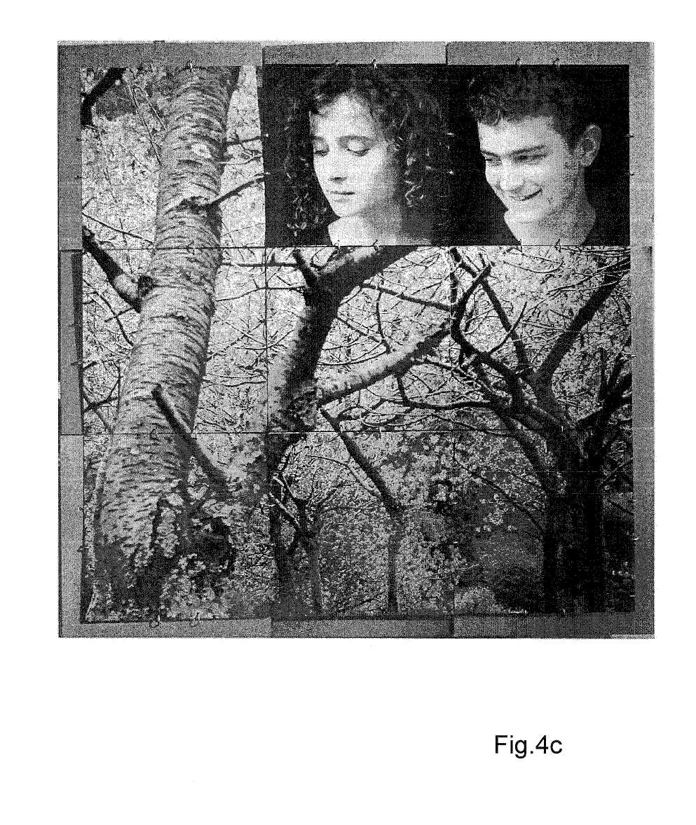

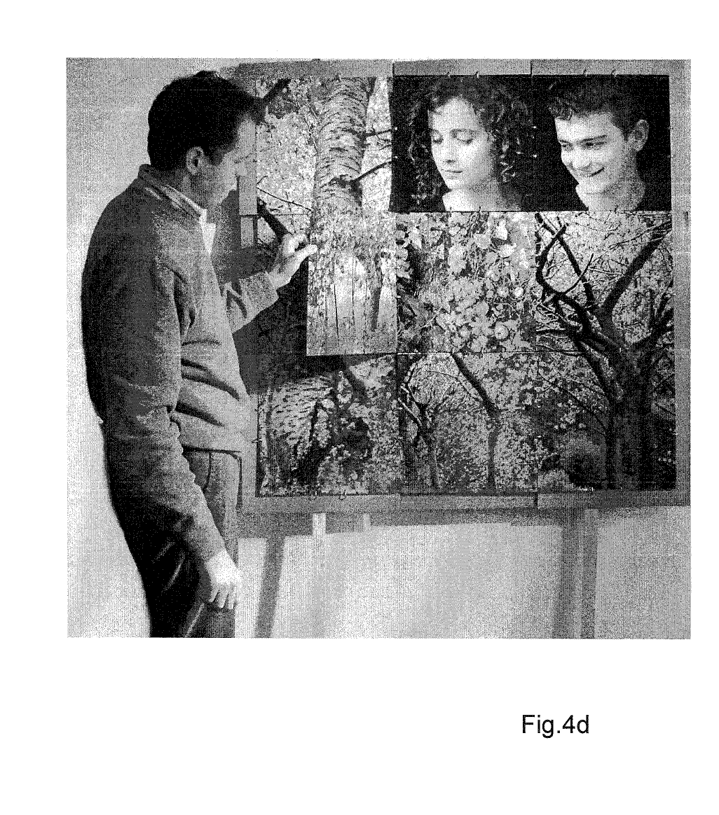

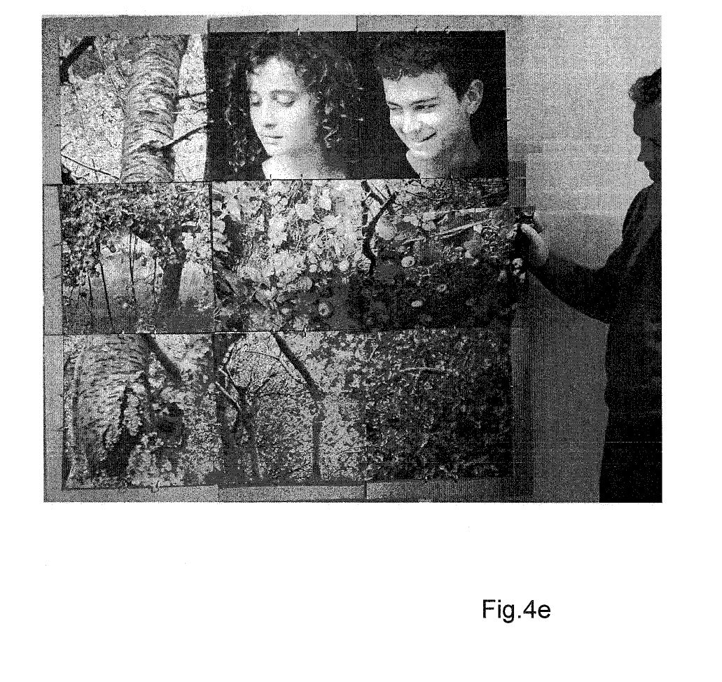

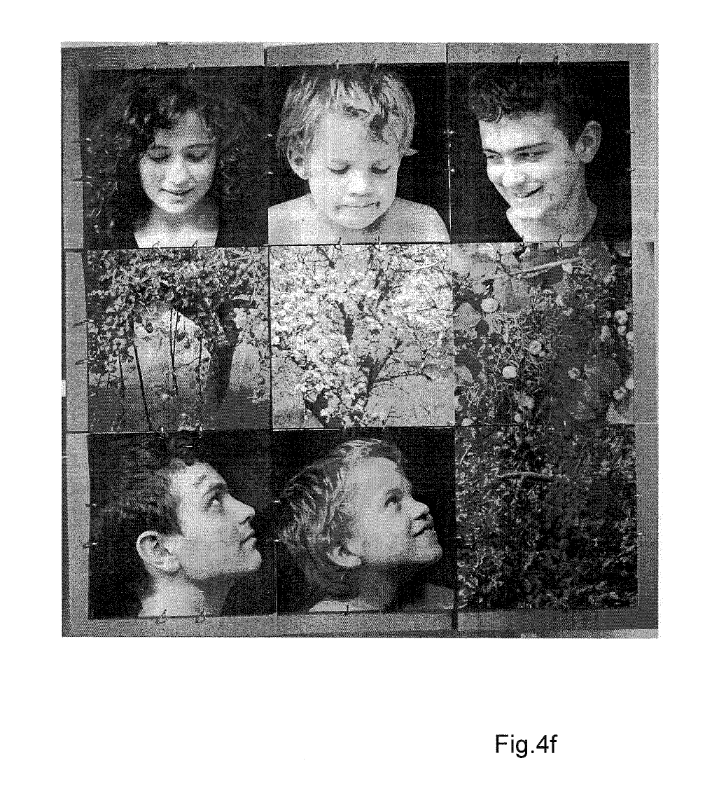

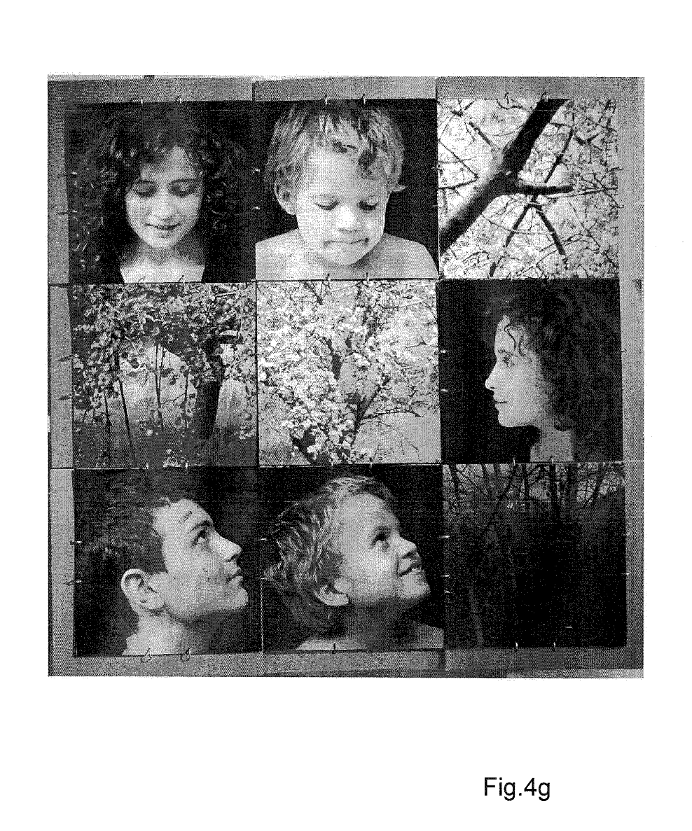

FIG. 4a-g show another exemplary embodiment of the display in various configurations, and.

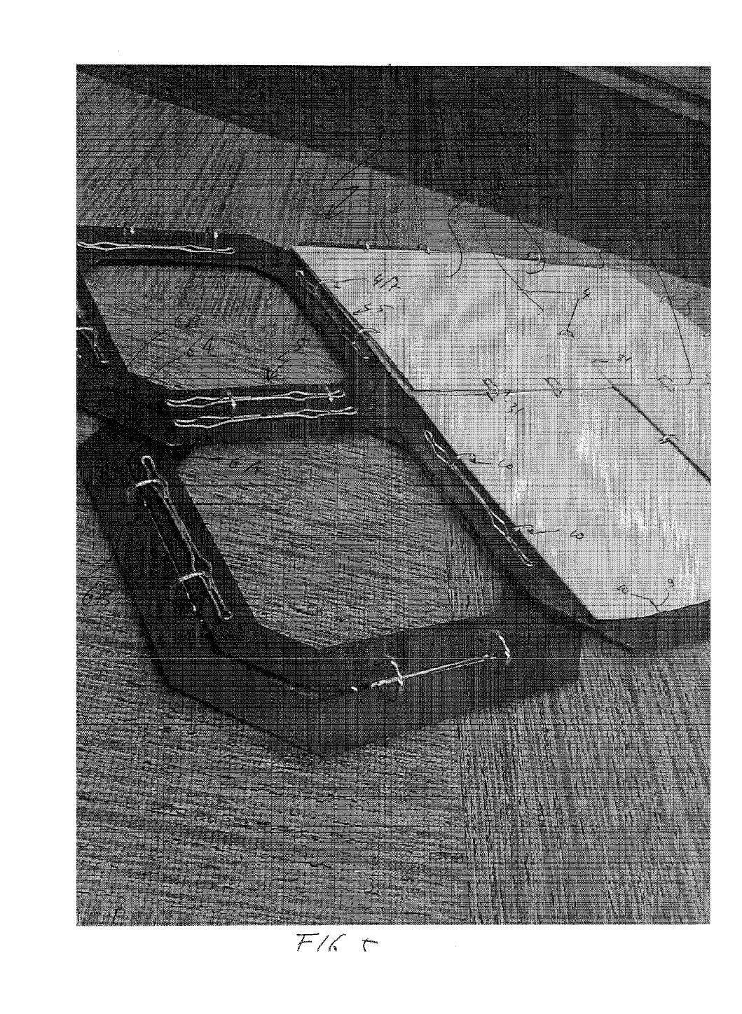

FIG. 5 shows a detail of yet another embodiment with overlapping carrier, ring shaped segments.

The figures show only schematic representations of exemplary embodiments, and are shown as non-limiting examples only. In the figures, similar or corresponding parts have been provided with the same reference numerals.

FIG. 1 shows a display 1 that may be used for decoration, in particular to display a number of different photographs. The display 1 includes a plurality of panels 2 that are disposed for movement about a single flipping edge 3 only. The basic shape of the panels 2 is in this exemplary embodiment an equilateral triangle, and is the same for all the panels 2. The panels 2 are in this exemplary embodiment made of stiff paper, so as to be rigid and to keep a planar configuration. The panels 2 have two opposite faces A,B. The faces A,B of the panels 2 are in this exemplary embodiment both provided with a photographic image. The photographic images on some of the faces may for example be a partial image, so that the faces together form a large image, such as the crown of a tree. The photographic images on other faces may for example be individual images, for example portraits of people in a colour setting matching the colour of the crown of the tree.

As is shown in FIG. 2, the panels 2 may each be flipped manually about a flipping edge 3 from a first position I in which one face A of the panel faces front, to a second position II in which an opposite face B of that panel 2 faces front. The first and second positions I, II lie in a substantially flat plane, in this example the base plane of the display.

In this exemplary embodiment, the panels 2 are disposed on hinges 4 as connections, and panels 2 have only one degree of freedom, which is a rotation about a flipping edge 3. The hinges 4 are here embodied as double ring clamp mechanisms 5 of the type that are commonly used in ring binders, and are effectively configured as linear hinges. The panels 2 are releasably carried on the hinges, and may be added or removed by operating the clamp mechanisms 5.

In this exemplary embodiment, the panels 2 are supported on a carrier, which in the top view of FIG. 1 is obstructed from view by the panels 2. The carrier is here built up of a number of carrier segments 6, that are interconnected by the hinges 4. As may be seen in FIG. 2, the flipping edges 3 of the carrier segments 6 are carried on the O rings 7 of the clamp mechanisms, and are supported on the backs 8 of the clamp mechanisms 5. Each carrier segment 6 corresponds with a position I or II of a panel 2. To enhance the number of configurations, the top face of the carrier segment may also be provided with an image.

As shown on an enlarged scale in FIG. 3, to allow flipping edges 3 of adjacent panels 2 to be positioned in close proximity, the area along unhinged flipping edges 3′ of the panels are be provided with apertures 9, such as open slits, to accommodate parts of the hinges without enclosing, i.e. without being carried on that hinge 4. Such apertures may also be used to secure the panels 2 in the base plane. The area along the hinged flipping edge 3 of the panel 2 may then be provided with apertures 10, such as circular cut-outs, that enclose parts of the hinges.

The display 1 includes a plurality of sets of two panels 2′, 2″. The panels 2′, 2″ of each set are disposed such that their flipping edges 3 include an angle so as to extend at least partially transversely relative to each other. In this exemplary embodiment, the flipping edges 3 of the set of panels 2′,2″ extend at an angle of about 30 degrees. One of the positions of the set of panels 2′, 2″, in this example position II, fully overlaps. The panels 2′, 2″of the sets are thus each disposed to hinge about an hinge axis H extending substantially along the flipping edge of the panel, hinge axis H extending at an angle of 30 degrees relative to each other. In this exemplary embodiment, more than one set of two panels 2′,2″ is thus disposed with their flipping edges 3 extending at an angle relative to each other, and having one of their positions at least partially overlapping, so that the panels of that set may overlap at least partially in another common position. In FIG. 2, two sets of panels are indicated. However, the display 1 in fact includes ten sets 2′, 2″.

Further, in this exemplary embodiment, each set of panels 2′,2″ is part of a group of two panels 2 that is grouped with their flipping edges 3 in a bundle. The set of panels 2′,2″ may thus include more than two panels. By grouping panels 2 in a bundle, the display 1 may take on more configurations. For example, in this exemplary embodiment the crown of the tree may be for example depicted on the faces of the various panels 2 as being in different seasons.

The display 1 may be operated by flipping panels about a flipping edge from a first position in which one face of the panel faces front, to a second position in which an opposite face of that panel faces front, such that panels are flipped so as to arrive at a common position from directions that are oriented substantially transversely. This way, the display may be configured by the public at will, but within the boundaries set by the limited movement of the panels, so that it may arrive at embedded image configurations. The public may for example flip the panels to change the display, e.g. to adapt the parts of the crown of the tree that are depicted to the season of the year, and choose the portraits to be shown to give it a fresh appearance.

The display of the exemplary embodiment is shown in FIG. 1 in assembled condition. It may, however be disassembled by opening the rings 7 of the clamp mechanism 5, and removing one of the carrier plates 6 from the rings 7. This way, ten modules remain that each include a carrier plate 6 to which two panels 2 are connected via the hinge 4 formed by the clamp mechanism 5. These modules may be stacked, and stored in a housing (not shown) of which the length and width substantially corresponds with the length and width of the carrier plates 6. If desired, the modules may be disassembled down to their components. The housing may be provided with assembly instructions, and may e.g. be sold as kit of parts.

FIGS. 4a-g show a set of photographs of another exemplary embodiment of a display according to the invention in various configurations. The display has a build that is similar to the display in the previous example, but the panels and carrier segments are square. The carrier segments are plate like and are arranged in three rows of three segments. The carrier segments at the flipping edges are rectangular and larger than the panels, while the carrier segment in the centre (not visible) is square and of the same size as a panel. The segments are interconnected by clamp mechanisms at all adjacent flipping edges. The clamp mechanisms each include two rings that may hingedly carry a panel. In addition, the carrier segments are provided with clamp mechanisms at the flipping edges of the panels that form the outer periphery of the array of panels. These outer clamp mechanisms need not carry panels. They may be used to secure unhinged flipping edges of the panels at the periphery of the array in the base plane of the display by cooperating with slit like apertures in the flipping edges of the panels. The clamp mechanisms at the upright adjacent flipping edges of the carrier segments form hinges of which the hinge axis extend vertically, while the clamp mechanisms at the transverse flipping edges of adjacent carrier segments form hinge axis that extend horizontally. The clamp mechanisms at adjacent flipping edges of the carrier segments each hingedly carry at least two double faced panels.

FIG. 4a shows the display in a base configuration. FIG. 4b shows that a panel at the position 1.3 (third position of the top row) is being flipped about its left flipping edge towards the position 1.2 (second position top row). In FIG. 4c it is shown that the panel has arrived at the position 1.2 In FIG. 4d it is shown that the panel at the position 2.2 (second position, second row) is being flipped about its left flipping edge towards the position 2.1 (first position, second row). In FIG. 4e it is shown that the panel has arrived at the position 2.1, and that a panel at the position 2.3 (third position, second row) is being flipped about its lower flipping edge to a position 3.3. (third position, third row). In FIGS. 4f and 4g, two different positions of the display are shown, after various panels have been flipped and arranged by the interacting member of the public. These positions show how, with one and the same display, an interacting member of the public can explore and create a large but limited number of totally different views of the display by re-arranging the panels. On the one hand, there are clear patterns that are “programmed” in the display by the artist as he has fixed certain panels to certain axes, which limits the viewer's interaction. On the other hand, the number of possible views is so big, already in a display with several sets with a few number of panels, that there are always unexpected patterns to be explored and found. This illustrates how the display can serve as a communication tool between the artist and interacting members of the public.

In yet another embodiment, shown in FIG. 5, the edges of the carrier segments 6 may overlap to enhance stiffness of the construction. Such overlapping edges of the segments may be clamped onto each other using a clamp mechanism 5 of which the rings 6 reach through the segments, and onto which clamps are provided which press down onto underlying panels 2 and carrier segments 6 as they would do in an office ring binder. As an alternative, the carrier segments 6 may at their overlapping zone be permanently connected using e.g. glue, or releasably connected using a snap or screw connection. For example, the carrier segments may be coupled using a bridge portion with hollow threaded studs projecting there from, which studs reach through apertures in the carrier segments. Nuts may then be screwed onto outer thread of the studs to clamp the carrier segments onto the bridge portion. The hinges may then e.g. be formed by loops which are snapped or fitted tightly into the hollow studs.

Advantageously, as also shown in FIG. 5, the carrier segments 6 may be ring shaped, e.g. square rings with beveled or rounded edges. Such ring shaped segments may be manufactured efficiently in different sizes in a nested arrangement, preferably by cutting or stamping them from a plate of relatively stiff material such as metal, wood or hard plastic. To facilitate mounting the relatively stiff ring shaped carrier segments rings over the rings 7 of the clamp mechanism 5, the ring shaped carrier segments may be embodied as two separate concentric rings.

Further, a square panel 2 for the display 1 may elegantly be along three unhinged edges 3′ of its circumference be provided with a set of circular holes 10, each spaced form each other to correspond with the distance between two rings 7 of the clamp mechanism 5, and spaced from the edge 3′ of the panel with a slit 9 extending from the edge 3′ of the panel 2 to the hole 10. A fourth hinged edge 3 may then be provided with an identical set of holes 10 without slit. A punch with a keyhole shaped cutting member may be provided for making the holes 10 with a slit 9

It shall be clear to the skilled person that the invention is not limited to the exemplary embodiment described and that many variations are possible within the frame work of the invention as defined in the appended claims.

### REFERENCE SIGNS

1. Display
2. Panel (2′,2″ set)
3. Flipping edge (3 hinged, 3′unhinged)
4. Hinge
5. Clamp mechanism
6. Carrier segment
7. Ring
8. Back
9. Apertures (slits)
10. Apertures (holes)
I First position
II Second position
H Hinge axis

1. A display including a plurality of panels that are disposed for movement about a single flipping edge only, wherein the panels are configured to be flipped manually about said flipping edge from a first position in which one face of the panel faces front, to a second position in which an opposite face of that panel faces front, the display including at least one set of at least first and second panels, characterized in that the first and second panels of said at least one set are disposed such that their flipping edges extend at least partially transversely relative to each other, and such that one of their respective first and second positions at least partially overlaps with one of the first and second positions of the other in a common position.

2. The display of claim 1, wherein the panels of the set are each disposed to hinge about an axis extending substantially along the flipping edge of the panel, and wherein the hinge axes extend at an angle relative to each other.

3. The display of claim 1, wherein the first and second positions lie in a substantially flat plane.

4. The display according to claim 1, wherein at least one of the first and second panels may be placed in at least one intermediate position located between its first and second position.

5. The display of any of claims 1, wherein more than one set of at least first and second panels are disposed with their flipping edges extending transverse to each other, and having one of their first and second positions at least partially overlapping, so that the at least first and second panels of that set may overlap at least partially in another common position.

6. The display of claim 1, wherein at least one set of panels includes a plurality of panels grouped with their flipping edges in a bundle.

7. The display of claim 1, wherein the panels are hingedly disposed on hinged connections.

8. The display of claim 7, wherein the panels are releasably carried on the hinged connections.

9. The display of claim 1, wherein the panels have only one degree of freedom, which is a rotation about flipping edge.

10. The display of claim 1, wherein the panels are supported on a carrier.

11. The display of claim 10, wherein the carrier is built up of a number of carrier segments.

12. The display of claim 11, wherein each carrier segment corresponds with a position of a panel.

13. The display of claim 11, wherein the carrier segments are detachably interconnected.

14. The display of claim 13, wherein the carrier segments are interconnected via hinged connections that carry panels at their flipping edges.

15. The display of claim 1, wherein the basic shape of the panels is mutually substantially the same.

16. The display of claim 15, wherein the panels are one of polygonal, square, triangular or rectangular.

17. The display claim 1, wherein the flipping edges of the first and second panels extend substantially normal relative to each other.

18. The display of claim 1, wherein the panels are rigid.

19. A kit for a display according to claim 10, comprising a plurality of panels, a carrier and a plurality of hinges for defining the flipping edges of the panels.

20. The kit according to claim 19, wherein the carrier is segmented so that each segment corresponds with a position of a panel.

21. The kit according to claim 19, in which the panels and carrier is contained in a housing of which the basic length and width dimensions correspond to the larger of those of a panel and a carrier segment.

22. A method of operating a display, in which panels may be flipped about a flipping edge from a first position in which one face of the panel faces front, to a second position in which an opposite face of that panel faces front, in which the panels are configured to be flipped so as to arrive at a common position along flipping edges that are oriented substantially transversely.
